(19) United States
(12) Patent Application Publication
(10) Pub. No.: US 2008/0205397 A1
(43) Pub. Date: Aug. 28, 2008

(54) METHOD FOR FORWARDING MULTICAST PACKETS IN A VIRTUAL PRIVATE LOCAL AREA NETWORK SERVICE

(75) Inventor: Xiaohu XU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/044,428

(22) Filed: Mar. 7, 2008

Related U.S. Application Data
(63) Continuation of application No. PCT/CN2006/000949, filed on May 12, 2006.

(30) Foreign Application Priority Data
Sep. 7, 2005 (CN) 200510098649.2

(51) Int. Cl. H04L 12/56

(52) U.S. Cl. 370/390

(57) ABSTRACT

A method for forwarding multicast packets in a virtual private LAN includes: the VPLS VSI monitors PIM messages received by the interfaces and configures the L2 multicast route according to the messages; then the VPLS VSI forwards multicast packets according to the L2 multicast route configured. With the PIM Snooping function, the VSI may forward multicast packets precisely so that the bandwidth of an MPLS or IP network can be effectively saved and that the multicast replication pressure between PEs in the VPLS network and VC pseudowires in the VSI can be reduced.

### CROSS-REFERENCE TO RELATED APPLICATIONS

This application is a continuation of International Patent Application No. PCT/CN2006/000949, filed May 12, 2006, which claims priority to Chinese Patent Application No. 200510098649.2, filed Sep. 7, 2005, both of which are hereby incorporated by reference.

### FIELD OF THE INVENTION

The present invention relates to the communication field, and in particular, to a method for forwarding multicast packets in a virtual private local area network Service (VPLS).

### BACKGROUND OF THE INVENTION

Virtual Private LAN Service (VPLS), also known as Transparent LAN Service (TLS), is a layer-2 Virtual Private Network (L2 VPN) technology adapted to provide point-to-multipoint communications in a Multi-Protocol Label Switching (MPLS) or IP network. VPLS is used by more and more operators to provide VPN services for enterprise users. VPLS may be viewed as a group of virtual switching instances (VSIs), which, connected through Ethernet over MPLS (EoMPLS) virtual circuits, form a logical Ethernet switch.

VPLS VSI works on a similar principle to that of an Ethernet switch, including MAC address learning and Ethernet frame forwarding based on a MAC address. If the destination MAC address of an Ethernet frame is an unknown unicast address or a multicast or broadcast address, the Ethernet frame is flooded to all interfaces in a VSI, including physical interfaces and virtual link interfaces which are also known as VC pseudowires. Customer Edges (CEs) are connected with a VPLS VSI, as if they are connected with an Ethernet switch.

Protocol Independent Multicast-Sparse Mode (PIM-SM) is a multicast routing protocol independent of specific unicast routing protocols and can check reverse path forwarding (RPF) by using an existing unicast routing table.

PIM-SM sends Join or Prune messages through a protocol independent multicast (PIM) router and establishes a rendezvous-point-based rendezvous point tree (RPT) or a source-based shortest path tree (SPT). Multicast packets are forwarded to multicast group members in different network segments along the RPT or SPT.

In a networking environment with a VPLS network as the core network and with PIM-SM routers, multicast packets are forwarded on the basis of the principle of VPLS VSI.

FIG. 1 shows the forwarding of a multicast flow in VPLS realized in the prior art. In the networking structure, there are a VPLS VSI and three customer edge routers CE-1, CE-2, and CE-3, which are connected with a multicast source, a receiver, and a non-receiver respectively.

After CE-1 forwards a multicast packet to the VPLS network, the VSI floods the multicast packet to all the interfaces in the VSI; that is, the multicast packet is forwarded to all the interfaces in the VSI. Both CE-2 and CE-3 can receive the multicast packet. CE-2 forwards the multicast packet to receivers in the multicast group, whereas CE-3 discards the multicast packet directly.

In the above technical solution, the multicast packet is forwarded to CE-3 although CE-3 is not connected with receivers in the multicast group. This kind of extensive forwarding of a multicast flow not only adds to the multicast replication pressure between provider edges (PEs) in a VPLS network and VC pseudowires in a VSI but also leads to a waste of network bandwidth in transmission.

### SUMMARY OF THE INVENTION

The present invention provides a method for forwarding multicast packets in a virtual private LAN so that the PIM snooping function can be realized and multicast packets can be forwarded precisely in a VSI. Thus the bandwidth in an MPLS or IP network is saved and the multicast replication pressure between PEs in a VPLS network and VC pseudowires in a VSI is lessened.

The objectives of the present invention are achieved through the following technical solution.

A method for forwarding multicast packets in a virtual private LAN includes:

by a VPLS VSI, monitoring the PIM messages received by its interfaces and configuring L2 multicast routes according to information in the messages; and

forwarding multicast packets according to the routes configured.

The VPLS VSI analyzes PIM messages. If a PIM Join message is received, the VSI obtains a multicast MAC address according to the IP address of the multicast group in the message, and configures L2 multicast routes accordingly.

The VPLS VSI checks in the L2 multicast routes whether the obtained multicast MAC address exists. If the address does not exist, the VSI generates an L2 multicast forwarding entry and adds the interface that receives the PIM Join message to the egress interface information of the forwarding entry. If the address exists, the VSI checks whether the egress interface information of L2 multicast routes contains the interface that receives the PIM Join message and, if not, adds the interface that receives the PIM Join message to the egress interface information.

In response to adding the interface that receives the PIM Join message to the egress interface information, the VSI sets the time to live for the egress interface.

After the VSI confirms that the egress interface information of L2 multicast routes contains the interface that receives the PIM Join message, the VSI resets the time to live for the egress interface.

When the time to live expires, the VSI deletes the egress interface information from the egress interface information of L2 multicast routes.

The VPLS VSI analyzes PIM messages. If a PIM Prune message is received, the VSI obtains a multicast MAC address according to the IP address of the multicast group in the message, and configures L2 multicast routes accordingly.

The VSI searches L2 multicast routes for the forwarding entry corresponding to the multicast MAC address obtained. If an entry is matched, the VSI deletes the interface that receives the Prune message from the egress interface information.

If it is confirmed that the egress interface information in the L2 multicast forwarding entry is null, the VSI deletes the entry from the L2 multicast routes.

When the VSI receives a multicast packet, the VSI searches L2 multicast routes for an entry corresponding to the destination MAC address in the multicast packet. If an entry is matched, the VSI forwards the multicast packet through all the egress interfaces included in the entry.

If no entry is matched, the VSI forwards the multicast packet to all the interfaces connected to the VSI.

The VSI floods the multicast packet to all the interfaces and sends one copy of the packet to the service processing system for processing.

In the above technical solution provided in the present invention, the VPLS VSI monitors PIM messages received by all the interfaces and configures L2 multicast routes according to the information in the PIM messages; then the VSI forwards data flows according to the routes. An embodiment of the present invention provides a method so that a PIM snooping function can be realized and that multicast packets can be forwarded precisely in a VSI; thus the bandwidth in an MPLS or IP network can be saved and the multicast replication pressure between PEs in a VPLS network and VC pseudowires in a VSI can be lessened.

### BRIEF DESCRIPTION OF THE DRAWINGS

FIG. 1 shows the forwarding of a multicast flow in VPLS realized in the prior art;

FIG. 2 shows a flowchart of an embodiment of the present invention;

FIG. 3 shows a flowchart for configuring L2 multicast routes according to a PIM message according to the present invention;

FIG. 4 shows the precise forwarding of a multicast packet in a VPLS VSI with PIM Snooping enabled according to the present invention; and

FIG. 5 shows the flooding of a PIM message in a VSI and the sending of one copy of the message to the CPU according to the present invention.

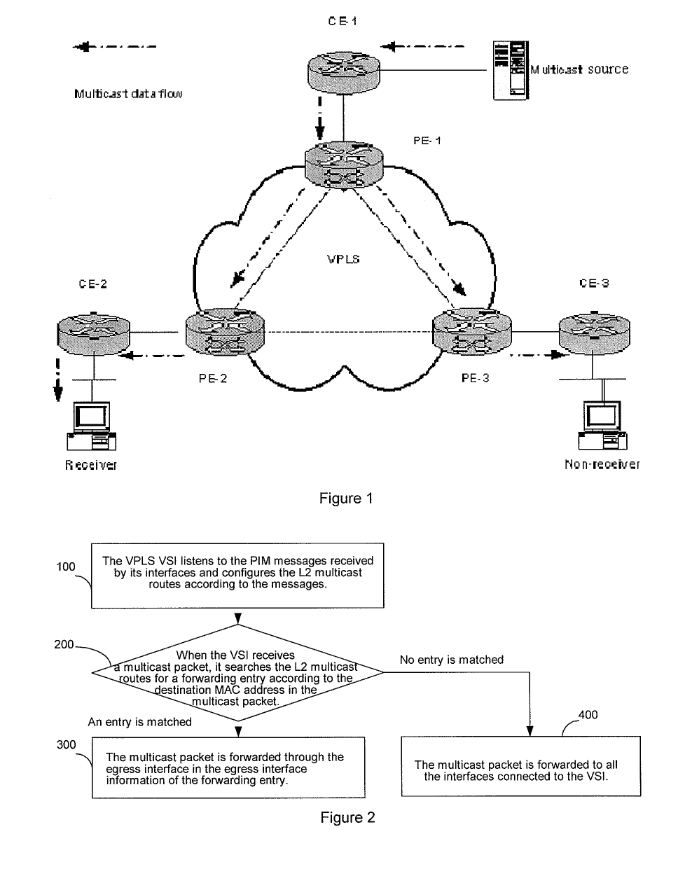

### DETAILED DESCRIPTION OF THE EMBODIMENTS

The present invention provides a method for forwarding multicast packets in a virtual private LAN. The core idea is: a VPLS VSI listens to the PIM messages received by its interfaces and configures L2 multicast routes according to the PIM messages; multicast packets are forwarded according to the routes configured.

In an embodiment of the present invention, multicast packets are forwarded precisely in a VPLS network with PIM Snooping enabled and the bandwidth of an MPLS or IP network can thus be saved. FIG. 2 shows the flowchart of an embodiment of the present invention. In block 100, the VPLS VSI listens to the PIM messages received by its interfaces and configures L2 multicast routes according to the PIM messages. When the VSI receives a multicast packet, the VSI searches the L2 multicast routes for a forwarding entry corresponding to the destination MAC address in the multicast packet in block 200. In block 300, the VSI forwards the multicast packet through the egress interface in the egress interface information of the forwarding entry if a forwarding entry is matched. If no entry is matched, the multicast packet is forwarded to all the interfaces connected to the VSI in block 400.

The above blocks are used to realize the basic solution of an embodiment of the present invention. The method is further described in detail hereinafter.

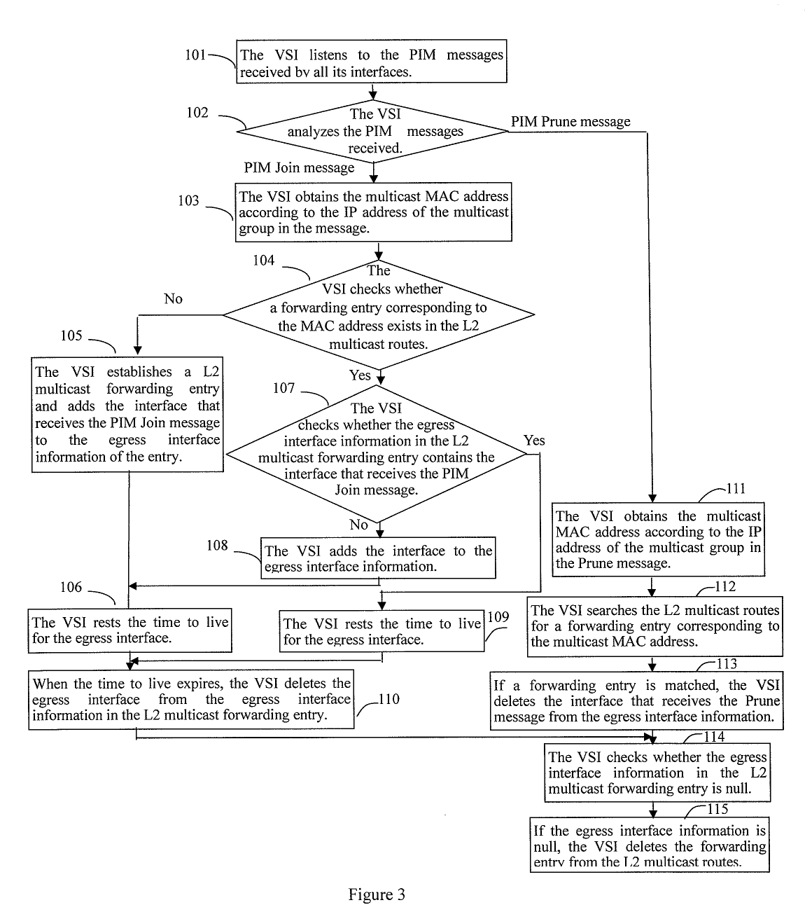

FIG. 3 shows a flowchart for configuring L2 multicast routes according to PIM messages. In block 101, the PIM Snooping module of the VSI listens to the PIM messages received by all the interfaces in the VSI including physical interfaces and VC pseudowires. In block 102, the VPLS VSI analyzes the PIM messages received. The VSI establishes, updates, or deletes L2 multicast forwarding entries according to a PIM Join message or Prune message. In block 103, if the PIM message received is a PIM Join message, the VSI obtains the multicast MAC address according to the IP address of the multicast group in the Join message. In block 104, the VSI checks its L2 multicast routes for a forwarding entry corresponding to the multicast MAC address. In block 105, if no such forwarding entry exists, the VSI establishes a L2 multicast forwarding entry and adds the interface that receives the PIM Join message to the egress interface information of the L2 multicast forwarding entry. Then the VSI sets the time to live for the egress interface in block 106.

If a forwarding entry corresponding to the MAC address is included in the L2 multicast routes, the VSI checks whether the egress interface information in the forwarding entry contains the interface that receives the PIM Join message, in block 107, and if not, adds the interface to the egress interface information in block 108. Then the VSI sets the time to live for the egress interface in block 106. If the egress interface information in the forwarding entry contains the interface that receives the PIM Join message, the VSI resets the time to live for the egress interface in block 109. When the time to live expires, the VSI deletes the egress interface from the egress interface information in the L2 multicast forwarding entry in block 110 and checks whether the egress interface list in the L2 multicast forwarding entry is null in block 114. If the egress interface list is null, the VSI deletes the L2 multicast forwarding entry from the L2 multicast routes in block 115.

In the above blocks, the VSI with PIM Snooping enabled establishes an L2 multicast forwarding entry according to the address of the multicast group in the Join message. The VSI then adds the interface that receives the Join message to the egress interface information and sets the time to live of the egress interface to the initial value. If the multicast MAC address corresponding to the IP address of the multicast group exists in the L2 multicast routes, the VSI further checks whether the egress interface information of the entry includes the interface that receives the PIM Join message. If the egress interface information of the entry does not include the interface, the VSI adds the interface to the egress interface information and sets the time to live of the egress interface to the initial value. If the egress interface information of the entry includes the interface, the VSI resets the time to live for the egress interface.

If the message received is a PIM Prune message as confirmed in block 102, the VSI obtains the multicast MAC address in block 111 according to the IP address of the multicast group in the message. In block 112, the VSI searches the L2 multicast routes for a L2 multicast forwarding entry corresponding to the multicast MAC address. If an entry is matched, the VSI deletes the interface that receives the Prune message from the egress interface information in block 113 and checks in block 114 whether the egress interface information in the L2 multicast forwarding entry is null. If the egress interface information is null, the VSI deletes the L2 multicast forwarding entry from the L2 multicast routes in block 115.

After the above blocks, the VSI with PIM Snooping enabled searches the L2 multicast routes for a forwarding entry by taking the MAC address as the index according to the address of the multicast group in the Prune message. If an entry is matched, the VSI deletes the interface that receives the Prune message from the egress interface information.

When the time to live of an egress interface in the egress interface information of an L2 multicast forwarding entry expires, the VSI deletes the interface from the egress interface information.

When the egress interface information of an L2 multicast forwarding entry is null, the VSI deletes the forwarding entry from the L2 multicast routes.

L2 multicast routes are configured in the VSI in the above blocks. After that, the VSI searches the L2 multicast routes for a forwarding entry corresponding to the destination MAC address in a multicast packet and forwards the multicast packet through all the interfaces listed in the egress interface information of the forwarding entry.

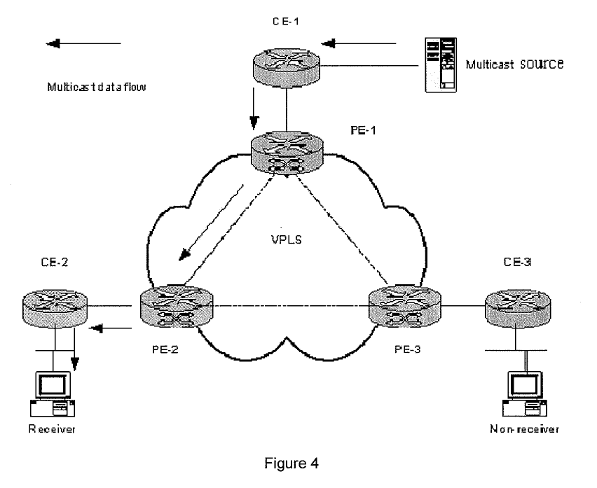

FIG. 4 shows the precise forwarding of a multicast packet in the VSI with PIM Snooping enabled.

In the networking structure in FIG. 4, CE-1, CE-2, and CE-3 are connected with the same VSI in a VPLS network. Specifically, CE-1 is connected with a multicast source; CE-2 is connected with a receiver; CE-3 is connected to a non-receiver.

The VSI with PIM Snooping enabled listens to the PIM Join messages from CE-2 and generates a forwarding entry G after it knows CE-2 joins a multicast group G. The VSI adds the interface that receives the Join message to the egress interface information.

When the VPLS network receives from CE-1 a multicast packet with G as the address of the multicast group, the VSI searches the L2 multicast routes according to the destination MAC address in the multicast packet. When the VSI finds a forwarding entry that matches G, the VSI forwards the multicast packet through all the interfaces listed in the egress interface information so that only CE-2 can receive the multicast packet with G as the address of the multicast group.

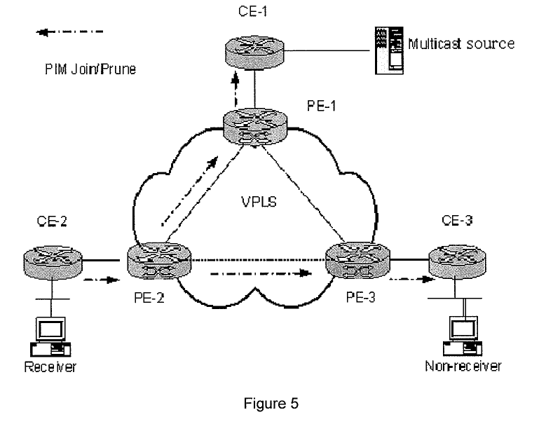

When the VSI floods a PIM multicast packet to all interfaces, the VSI also sends one copy of the packet to a service processing system, for example, the CPU. FIG. 5 shows the flooding of a PIM message in the VSI and the sending of one copy of the packet to the CPU. The VSI not only floods all PIM Join messages and Prune messages that match the entry (with PIM Snooping enabled, the entry is generated automatically) corresponding to the multicast address, but also sends a copy to the CPU so that the VSI can perform protocol processing through the PIM Snooping module.

As shown in the implementation of certain embodiment of the present invention, multicast packets can be forwarded precisely in the VSI with PIM Snooping enabled. In this way, the bandwidth of an MPLS or IP network can be effectively saved and the multicast replication pressure between PEs in the VPLS network and VC pseudowires in the VSI can be lessened.

Although the invention has been described through some exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for forwarding multicast packets in a virtual private Local Area Network
Service (VPLS), comprising:
monitoring a Protocol Independent Multicast, PIM, message received by an interface of a VPLS virtual switching instance (VPLS VSI);
configuring an L2 multicast route according to information in the message; and
forwarding a multicast packet according to the L2 multicast route.

2. The method of claim 1, wherein the VPLS VSI analyzes the PIM message; and if a PIM Join message is received, the VPLS VSI obtains a multicast Media Access Control (MAC) address according to the IP address of the multicast group in the message and configures the L2 multicast route accordingly.

3. The method of claim 2, wherein the VPLS VSI checks in the L2 multicast route for an entry corresponding to the obtained multicast MAC address; if no such entry exists, the VPLS VSI generates an L2 multicast forwarding entry according to the multicast MAC address and adds the interface that receives the PIM Join message to the egress interface information of the forwarding entry; if an entry is matched, the VPLS VSI checks whether the egress interface information of the L2 multicast route comprises the interface that receives the PIM Join message and; if the interface is not comprised, the VPLS VSI adds the interface that receives the PIM Join message to the egress interface information.

4. The method of claim 3, wherein the VPLS VSI sets the time to live for the egress interface in response to adding the interface that receives the PIM Join message to the egress interface information.

5. The method of claim 4, wherein the VPLS VSI resets the time to live for the egress interface in response to confirming that the egress interface information in the L2 multicast route comprises the interface that receives the PIM Join message.

6. The method of claim 5, wherein the VPLS VSI deletes the egress interface from the egress interface information in the L2 multicast route when the time to live of the egress interface expires.

7. The method of claim 2, wherein the VPLS VSI analyzes the received PIM messages; and if a PIM Prune message is received, the VPLS VSI obtains a multicast MAC address according to the IP address of the multicast group in the PIM Prune message and configures the L2 multicast route accordingly.

8. The method of claim 7, wherein the VPLS VSI searches the L2 multicast route for a forwarding entry corresponding to the multicast MAC address and, if a forwarding entry is matched, deletes the interface that receives the PIM Prune message from the egress interface information.

9. The method of claim 6, wherein the VPLS VSI deletes the forwarding entry from the L2 multicast route when the egress interface information in the forwarding entry is null.

10. The method of claim 1, wherein the VPLS VSI checks whether an forwarding entry corresponding to the destination MAC address exists in the L2 multicast route when the VSI receives a multicast packet; if an forwarding entry is matched, the VSI forwards the multicast packet through all the egress interfaces listed in the egress interface information of the matched forwarding entry.

11. The method of claim 10, wherein the VSI forwards the multicast packet to all the connected interfaces if no forwarding entry is matched.

12. The method of claim 11, wherein the VSI floods the multicast packet to all the interfaces and sends one copy to the service processing system for processing.

13. The method of claim 8, wherein the VPLS VSI deletes the forwarding entry from the L2 multicast route when the egress interface information in the forwarding entry is null.
